(19) United States
(12) Patent Application Publication
(10) Pub. No.: US 2025/0209352 A1
(43) Pub. Date: Jun. 26, 2025

(54) METHOD AND DEVICE FOR VALIDATING EXPLAINABILITY METHODS FOR A MACHINE LEARNING SYSTEM

(71) Applicant: Robert Bosch GmbH, Stuttgart (DE)

(72) Inventors: Andreas Steimer, Schoemberg (DE); Clint Sebastian, Stuttgart (DE); Jana Veser, Dannstadt-Schauernheim (DE); Laura Beggel, Stuttgart (DE); Mehul Bansal, Sindelfingen (DE); Thi Phuong Nhung Ngo, Karlsruhe-Neureut (DE)

(21) Appl. No.: 18/971,828

(22) Filed: Dec. 6, 2024

(30) Foreign Application Priority Data
Dec. 20, 2023 (DE) 10 2023 213 094.7

(51) Int. Cl. G06N 5/045

(52) U.S. Cl. CPC G06N 5/045

(57) ABSTRACT

A method for validating an attribution-based explainability method for a machine learning system. The method includes ascertaining synthetic data points using a generator according to a noise vector; ascertaining an output of the machine learning system by propagating the synthetic data point through the machine learning system and ascertaining an explanation output using the attribution-based explainability method for the ascertained output; ascertaining a score of the explanation output; optimizing the noise vector with regard to the score so that the score moves to the rear part of the distribution of scores; ascertaining further synthetic data points using a generator according to the optimized noise vector; ascertaining a further output of the machine learning system by propagating the further synthetic data points through the machine learning system and ascertaining a further explanation output using the attribution-based explainability method for the further ascertained output; and validating the attribution-based explainability method.

### CROSS REFERENCE

The present application claims the benefit under 35 U.S.C. § 119 of German Patent Application No. DE 10 2023 213 094.7 filed on Dec. 20, 2023, which is expressly incorporated herein by reference in its entirety.

### FIELD

The present invention relates to a method for validating an attribution-based explainability method for a machine learning system, a device, a computer program and a machine-readable storage medium.

### BACKGROUND INFORMATION

Attribution-based explainability methods are described in the literature.

Attribution-based explainability methods are also used, inter alia, to validate the machine learning systems they are intended to explain, while explainability methods are assumed to be valid and can therefore be used for validation. Given that validation by explainability methods is necessarily limited to a limited set of validation data, the explainability result for model validation can never be fully trusted. A challenge of attribution-based explainability methods is their validation so that the validation is ultimately reliable.

An object of the present invention is to provide a method for validating the explainability method so that a more reliable validation of machine learning systems can be carried out using the validated explainability method.

### SUMMARY

In a first aspect, the present invention relates to a computer-implemented method for validating an attribution-based explainability method for a machine learning system. According to an example embodiment of the present invention, the method begins with ascertaining synthetic data points by means of a generator according to a specified noise vector. This is followed by ascertaining an output of the machine learning system by propagating the synthetic data point through the machine learning system and ascertaining an explanation output by means of the attribution-based explainability method for the ascertained output. This is followed by ascertaining a score for the explanation output, which evaluates how likely or how frequently the corresponding explanation output occurs. This is followed by optimizing the noise vector with regard to the score in such a way that the score moves to the rear part of the distribution of scores. This is followed by ascertaining further synthetic data points by means of a generator according to the optimized noise vector. This is followed by ascertaining a further output of the machine learning system by propagating the further synthetic data points through the machine learning system and ascertaining a further explanation output by means of the attribution-based explainability method for the further ascertained output. This is followed by ascertaining the score of the further explanation output. This is followed by validating the attribution-based explainability method. Validation can be understood to mean a test with regard to suitability for a certain purpose. The test is preferably carried out by determining whether the score lies in a rear part of the distribution of the empirically ascertained distribution of explainability scores and whether the further synthetic data points do not lie in a rear part of the distribution of the synthetic data. In this case, there is a positive validation of the explainability method.

In a further aspect of the present invention, the validated attribution-based explainability method in accordance with the first aspect is used to validate the machine learning system with regard to the reliability of its outputs. According to an example embodiment of the present invention, this validated machine learning system is preferably used for classifying sensor signals, hereinafter referred to as classifier. Classification can be carried out by the following steps: receiving a sensor signal comprising data from the image sensor, determining an input signal that depends on the sensor signal, and feeding the input signal to the classifier in order to obtain an output signal that characterizes a classification of the input signal.

The image classifier assigns an input image to one or more classes of a specified classification. For example, images of series-manufactured, nominally identical products can be used as input images. For example, the image classifier can be trained to assign the input images to one or more of at least two possible classes that represent a quality assessment of the particular product.

The image classifier, e.g., a neural network, can be equipped with a structure such that it is trainable in order to identify and distinguish, e.g., pedestrians and/or vehicles and/or traffic signs and/or traffic lights and/or road surfaces and/or human faces and/or medical anomalies in imaging sensor images. Alternatively, the classifier, e.g., a neural network, can be equipped with such a structure that is trainable in order to identify spoken commands in audio sensor signals.

In principle, the concept of an image encompasses any distribution of information arranged in a two-dimensional or multi-dimensional grid. This information can, for example, be intensity values of image pixels recorded using any imaging modality, such as an optical camera, a thermal imaging camera or ultrasound. However, any other data, such as audio data, radar data or LIDAR data, can be translated into images and then classified in the same way.

According to the output of the validated machine learning system, a control variable can be ascertained. The control variable can be used for controlling an actuator of a technical system. The technical system can, for example, be an at least partially autonomous machine, an at least partially autonomous vehicle, a robot, a tool, a machine tool or a flying object such as a drone. The input variable can, for example, be ascertained according to detected sensor data and provided to the machine learning system. The sensor data can be detected by a sensor, e.g. a camera, of the technical system or alternatively received externally.

In further aspects, the present invention relates to a device and a computer program, each of which is configured to carry out the above methods of the present invention, and to a machine-readable storage medium on which this computer program is stored.

Example embodiments of the present invention will be explained in detail below with reference to the figures.

### BRIEF DESCRIPTION OF THE DRAWINGS

FIG. 1 schematically shows an information flow of an example embodiment of the present invention.

FIG. 2 schematically shows a flowchart of an example embodiment of the present invention.

FIG. 3 schematically shows an exemplary embodiment for controlling an at least partially autonomous robot, according to the present invention.

FIG. 4 schematically shows an exemplary embodiment for controlling a manufacturing system, according to the present invention.

FIG. 5 schematically shows an exemplary embodiment for controlling an access system, according to the present invention.

FIG. 6 schematically shows an exemplary embodiment for controlling a monitoring system, according to the present invention.

FIG. 7 schematically shows an exemplary embodiment for controlling a personal assistant, according to the present invention.

FIG. 8 schematically shows an exemplary embodiment for controlling a medical imaging system, according to the present invention.

### DETAILED DESCRIPTION OF EXAMPLE EMBODIMENTS

In summary, the idea of the present invention is to use generative models for validating explainability methods. This includes both optimization-based (a) and sampling-based approaches (b). With optimization-based approaches-similar to adversarial attacks-the generator is optimized in order to generate synthetic data, which causes the explainability method to fail. Sampling-based approaches, on the other hand, generate a large number of data instances and then investigate which of these instances lead to failures of the explainability method. In both cases, further investigation of the erroneous data then makes possible the characterization of the quality of the explainability method.

In the following, an option based on an optimization-based approach will be described by way of example, wherein the described procedure can be transferred analogously to sample-based approaches.

In the following, an existing attribution-based explainability method is assumed that has already been validated on a finite distribution of the input data of the model. This preliminary validation can be carried out using ground truth data from explanation outputs. The attribution-based explainability method can be applied to images. Attribution-based methods provide explainability scores for the different inputs (e.g., pixels) of a given data sample. The explainability values characterize the extent to which the machine learning system, hereinafter also referred to as model, has taken the particular inputs into account for its decision with regard to its output result.

Furthermore, it is assumed that the data are synthetic and come from a trusted generator, i.e., a generator that has been previously validated to generate realistic data.

Furthermore, a specific metric (referred to as a score metric) is assumed, which measures the probability that an explainability score falls within the empirically ascertained distribution of realistic explainability scores. This score metric can be calculated using a neural network. This neural network is preferably small and randomly initialized and maps the explanation output of the explainability method to a low-dimensional output. Feature vectors are taken from one of the last layers of the neural network, wherein their distribution is compared with regard to an overall distribution of such feature vectors for a current application. This can alternatively be calculated using a Fréchet inception distance (FID) metric. It is possible that this neural network is a pre-trained network, e.g. ImageNet.

Similarly, a further metric (referred to as data metric) is used in order to measure the association of a data sample in the empirical distribution of synthetic data. Therefore, it is important to distinguish between the data distribution (implied by the synthetic data generator) and the distribution of explainability scores (e.g., by a heat map of pixels for some image data). The data metric, like the score metric, can be calculated using a neural network.

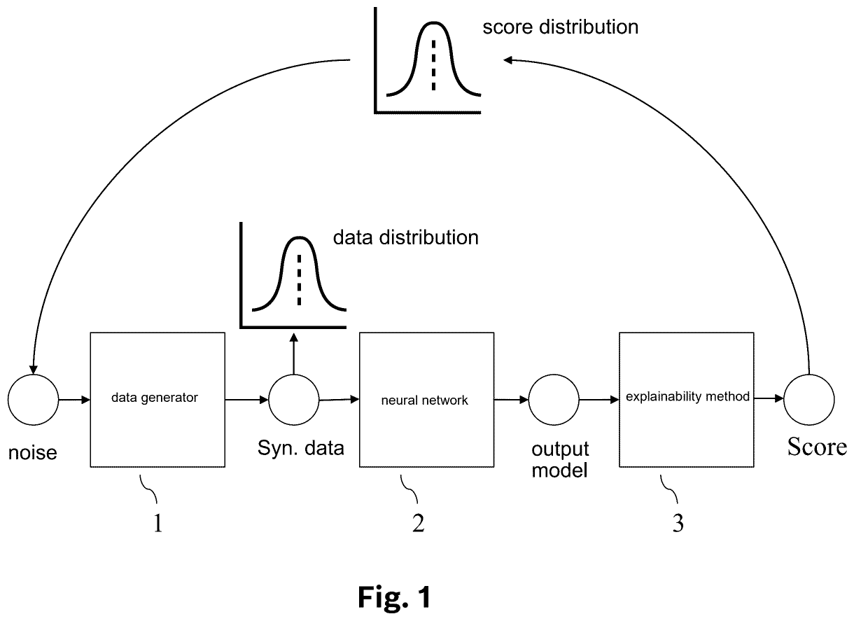

FIG. 1 schematically shows an information flow showing how synthetic data are optimized with regard to the relevant explainability method. The goal of the optimization is to drive the explainability value to the rear part of its distribution of the empirically ascertained distribution of realistic explainability scores. The rear part of a distribution can be understood to mean a specified percentile of the distribution, e.g. 5%. Due to the central limit theorem, it can be assumed that the distributions follow a normal distribution. However, any other distributions are also possible.

If the rear part of the distribution of explainability scores is reached, it is considered whether the corresponding generated synthetic data lie within a normal data distribution. If it does not also fall into a rear part of the distribution of synthetic data, the explainability method is not considered trustworthy, since typical data are capable of generating atypical explainability values.

The data generator 1 is preferably a data generator with random noise inputs for generating new data. Preferably, the data generator 1 has been validated with regard to its output of realistic data points, so that it substantially reliably generates synthetic data points which, for example, are substantially not classified as synthetic data points by a discriminator.

The present invention is based on the fact that the inputs of the data generator 1 are optimized, i.e. the generator parameters are not optimized. The generator parameters should remain constant so that the generator continues to generate realistic data. Due to this restriction of the optimization on the inputs, it is assumed that the correspondingly generated data, which arise from the noise that causes explainability method 3 to fail, are realistic data.

In detail, there is a two-stage process, with which the synthetic data generated by generator 1 (after data distribution) are fed into, for example, a neural network 2, for which the explainability method 3 is defined. This explainability method 3 generates an abstract score-based representation of the data (e.g., a heat map of the explainability scores), which is then evaluated using the score metric.

Similar to adversarial attacks, the goal of optimization is then to find some synthetic data to cause the explainability method to fail. That is, data that drive the explainability score into the rear part of its distribution, as measured by the evaluation metric. Once the rear part of the distribution of explainability values has been reached, the corresponding synthetic data are evaluated for their association in the data distribution with the aid of the data metric.

If the corresponding synthetic data falls in the rear part of the data distribution, the explainability method cannot be blamed, since it was designed/trained to work only on the data distribution, not on outliers. However, if the corresponding synthetic data are so-called in-distribution, it can be concluded that the explainability method on the data distribution is not fully valid.

Preferably, for a gradient-based optimization method, the pipeline shown in FIG. 1 is fully differentiable. If this is not the case, the gradient can either be calculated numerically or gradient-free optimization methods such as Bayesian optimization can be used.

If sampling is used instead of optimization methods, a large number of synthetic images would be used initially, which would then be evaluated using the explainability method and the score metric. This leads, on the one hand, to a certain data distribution and, on the other hand, to a certain explainability score distribution. Subsequently, the synthetic data that cause the rear part explainability score are ascertained and evaluated using the data metric.

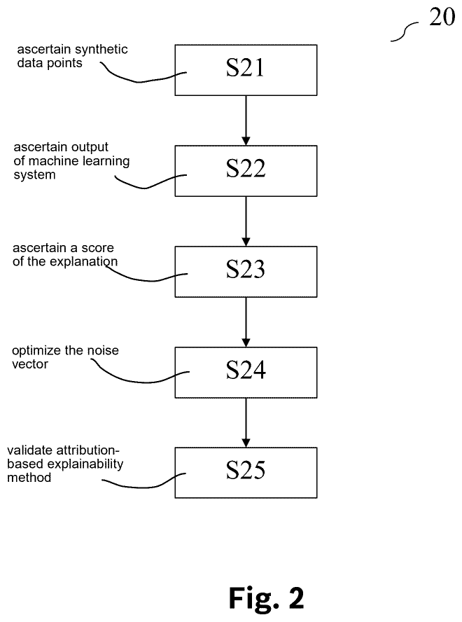

FIG. 2 schematically shows a method 20 for validating explainability methods.

The method begins with ascertaining S21 synthetic data points by means of a generator 1 according to one or more specified noise vectors. The noise vectors can be generated in accordance with Monte Carlo sampling.

This is followed by ascertaining S22 an output of the machine learning system 60 by propagating the synthetic data point through the machine learning system 60 and ascertaining an explanation output by means of the attribution-based explainability method 3 for the ascertained output.

This is followed by ascertaining S23 a score of the explanation output and optimizing S24 the noise vector with regard to the score in such a way that the score moves to the rear part of the distribution of scores. The optimization can be carried out using a Broyden-Fletcher-Goldfarb-Shanno (BFGS) method.

Using the optimized noise vector, the steps S21, S22 and S23 are executed again. Subsequently, either a validation S25 of the attribution-based explainability method (3) can be carried out, or after the steps S21-S23, an additional S24 can be carried out in order to repeat the steps S21, S22 and S23 with a further optimized noise vector.

If the explainability method is trustworthy in accordance with step S25, the explainability scores in the rear part of the distribution should be assigned exclusively to the data in the rear part of the data point distribution. On the other hand, if an explainability score in the rear part of a high-probability part of the data distribution is mapped to a typical data point/image, the explainability method must be concluded as faulty.

The validated explanation method shown in FIG. 2 can be used for validating the machine learning system. Subsequently, the validated machine learning system can be used for controlling a technical system.

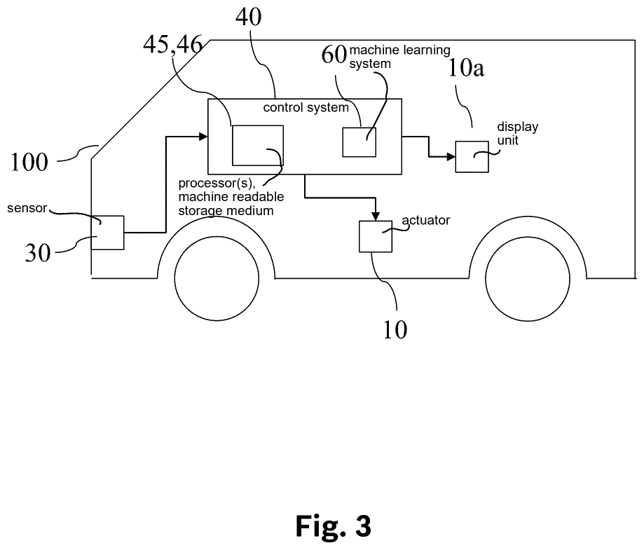

FIG. 3 schematically shows an actuator with a control system 40. At preferably regular time intervals, a surrounding region 20 of the actuator 10 is detected using a sensor 30, in particular an imaging sensor such as a video sensor, which can also be provided by a plurality of sensors, for example a stereo camera. Other imaging sensors are also possible, such as radar, ultrasound or lidar. A thermal imaging camera is also possible. The sensor signal S—or, in the case of a plurality of sensors, one sensor signal S each—of the sensor 30 is transmitted to the control system 40. The control system 40 thus receives a sequence of sensor signals S. The control system 40 ascertains therefrom control signals A, which are transmitted to an actuator 10. The actuator 10 can convert received control commands into mechanical movements or changes in physical quantities. The actuator 10 can, e.g., convert the control command A into an electrical, hydraulic, pneumatic, thermal, magnetic and/or mechanical movement or cause a change. Specific but non-limiting examples include electric motors, electroactive polymers, hydraulic cylinders, piezoelectric actuators, pneumatic actuators, servomechanisms, solenoids, stepper motors, etc.

The control system 40 receives the sequence of sensor signals S from the sensor 30 in an optional receiving unit 50, which converts the sequence of sensor signals S into a sequence of input images x (alternatively, the sensor signal S can also be adopted directly as the input image x). The input image x can, for example, be a portion or a further processing of the sensor signal S. The input image x comprises individual frames of a video recording. In other words, input image x is ascertained according to sensor signal S. The sequence of input images x is fed into the validated machine learning system, in the exemplary embodiment an artificial neural network 60.

The artificial neural network 60 is preferably parameterized by parameters that are stored in a parameter memory and are provided by the latter.

The artificial neural network 60 ascertains output variables y from the input images x. These output variables y can in particular comprise a classification and/or semantic segmentation of the input images x. Output variables y are fed into an optional transformation unit 80, which ascertains therefrom control signals A, which are fed into the actuator 10 in order to control the actuator 10 accordingly. Output variable y comprises information about objects detected by sensor 30.

The actuator 10 receives the control signals A, is controlled accordingly and executes a corresponding action. Here, the actuator 10 can comprise a control logic (not necessarily structurally integrated), which ascertains a second control signal from the control signal A, with which second signal the actuator 10 is then controlled.

In further embodiments, the control system 40 comprises the sensor 30. In still further embodiments, the control system 40 alternatively or additionally also comprises the actuator 10.

In further preferred embodiments, the control system 40 comprises one or more processors 45 and at least one machine-readable storage medium 46 on which instructions are stored that, if executed on the processors 45, cause the control system 40 to carry out the method according to the present invention.

In alternative embodiments, alternatively or in addition to the actuator 10, a display unit 10a is provided which can display an output variable of the control system 40.

In a preferred embodiment of FIG. 3, the control system 40 is used for controlling the actuator, which here is an at least partially autonomous robot, here an at least partially autonomous motor vehicle 100. The sensor 30 can, for example, be a video sensor preferably arranged in the motor vehicle 100.

The actuator 10, which is preferably arranged in the motor vehicle 100, can be, for example, a brake, a drive or a steering system of the motor vehicle 100. The control signal A can then be ascertained in such a way that the actuator or actuators 10 are controlled in such a way that the motor vehicle 100, for example, prevents a collision with the objects reliably identified by the artificial neural network 60, in particular if the objects are of certain classes, e.g. pedestrians.

Alternatively, the at least partially autonomous robot can be another mobile robot (not shown), for example one that moves by flying, swimming, diving or walking. The mobile robot can, for example, be an at least partially autonomous lawnmower or an at least partially autonomous cleaning robot. In these cases as well, the control signal A can be ascertained in such a way that the drive and/or steering system of the mobile robot are controlled in such a way that the at least partially autonomous robot prevents, for example, a collision with objects identified by the artificial neural network 60.

Alternatively or additionally, the control signal A can be used to control the display unit 10a and, for example, to display the ascertained safe regions. It is also possible, for example, in a motor vehicle 100 with non-automated steering, that the display unit 10a is controlled with the control signal A in such a way that it outputs an optical or acoustic warning signal if it is ascertained that the motor vehicle 100 is in danger of colliding with one of the reliably identified objects.

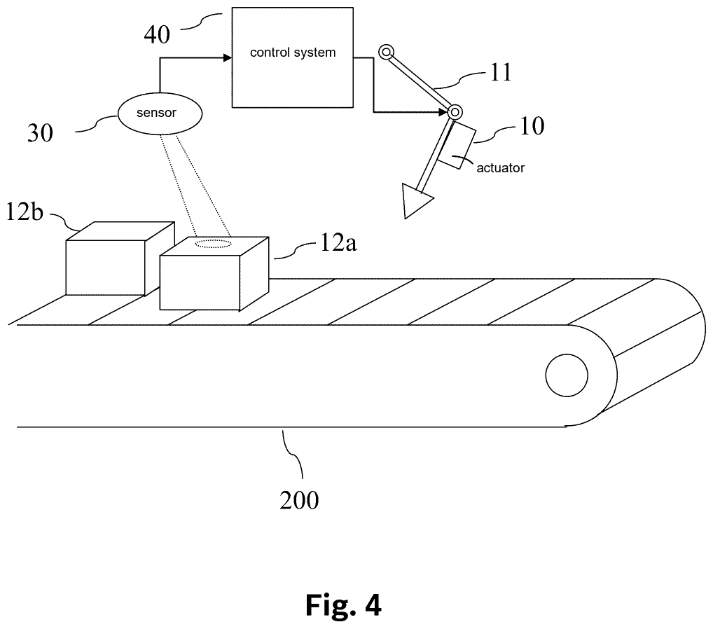

FIG. 4 shows an exemplary embodiment in which the control system 40 is used for controlling a manufacturing machine 11 of a manufacturing system 200 by controlling an actuator 10 controlling this manufacturing machine 11. The manufacturing machine 11 can, for example, be a machine for soldering, punching, sawing, drilling, milling and/or cutting or a machine that carries out a step of semiconductor production, such as chemical coating methods, etching and cleaning processes, physical coating and cleaning methods, ion implantation, crystallization or temperature processes (diffusion, baking, melting, etc.), photolithography or chemical-mechanical planarization.

The sensor 30 can then be, for example, an optical sensor that detects, e.g., properties of manufactured products 12a, 12b. It is possible that these manufactured products 12a, 12b are movable. It is possible that the actuator 10 controlling the manufacturing machine 11 is controlled according to an assignment of the detected manufactured products 12a, 12b, so that the manufacturing machine 11 accordingly carries out a subsequent processing step of the correct one of the manufactured products 12a, 12b. It is also possible that by identifying the correct properties of the same one of the manufactured products 12a, 12b (i.e., without a misassignment), the manufacturing machine 11 accordingly adapts the same manufacturing step for processing a subsequent manufactured product.

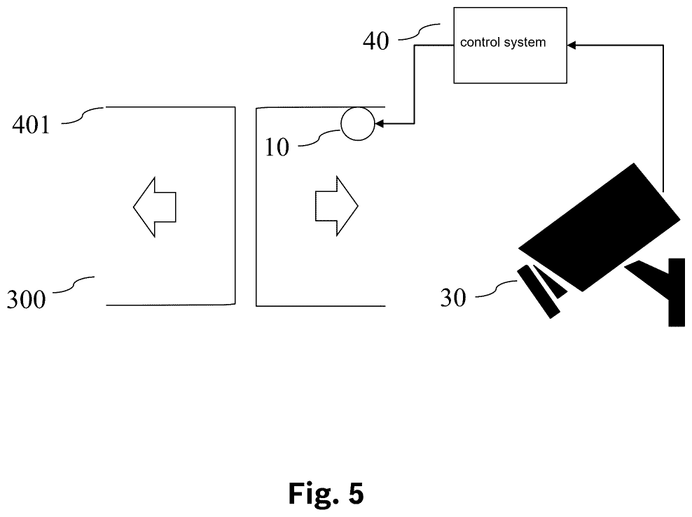

FIG. 5 shows an exemplary embodiment with which the control system 40 is used for controlling an access system 300. The access system 300 can comprise a physical access control, for example a door 401. Video sensor 30 is configured to detect a person. This detected image can be interpreted by means of the object identification system 60. If a plurality of persons is detected at the same time, the identity of the persons can be ascertained particularly reliably by assigning the persons (i.e., the objects) to one another, for example by analyzing their movements. The actuator 10 can be a lock that, according to the control signal A, releases the access control or not, for example opens the door 401 or not. For this purpose, the control signal A can be selected according to the interpretation of the object identification system 60, for example according to the ascertained identity of the person. Instead of physical access control, logical access control can also be provided.

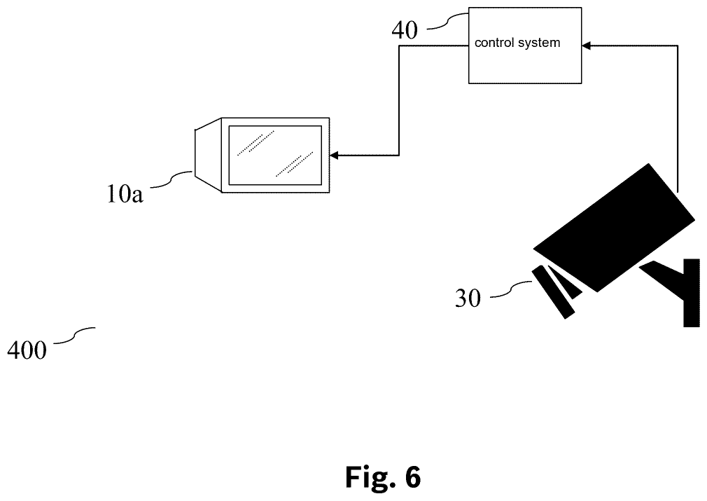

FIG. 6 shows an exemplary embodiment with which the control system 40 is used for controlling a monitoring system 400. This exemplary embodiment differs from the exemplary embodiment shown in FIG. 5 in that the display unit 10a, which is controlled by the control system 40, is provided instead of the actuator 10. For example, the artificial neural network 60 can reliably ascertain an identity of the objects recorded by the video sensor 30, in order to, according to this, e.g., deduce which ones are suspicious, and the control signal A can then be selected in such a way that this object is displayed in a highlighted color by the display unit 10a.

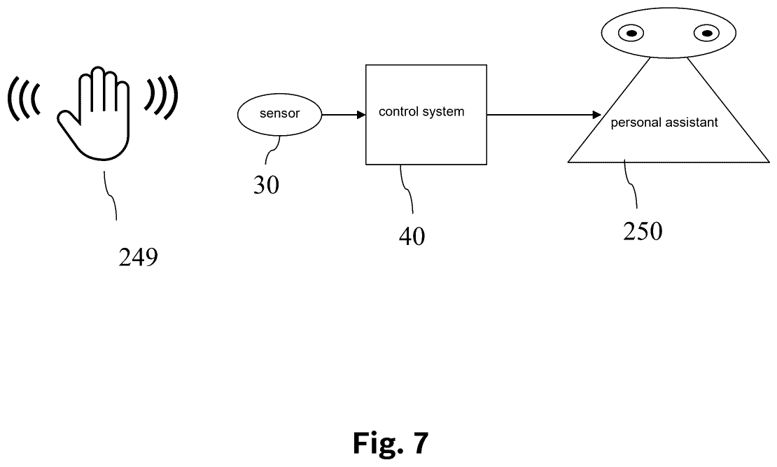

FIG. 7 shows an exemplary embodiment with which the control system 40 is used for controlling a personal assistant 250. The sensor 30 is preferably an optical sensor that receives images of a gesture of a user 249.

According to the signals from the sensor 30, the control system 40 ascertains a control signal A of the personal assistant 250, for example by the neural network carrying out gesture recognition. This ascertained control signal A is then transmitted to the personal assistant 250 and is thus controlled accordingly. This ascertained control signal A can in particular be selected in such a way that it corresponds to a presumed desired control by the user 249. This presumed desired control can be ascertained according to the gesture recognized by the artificial neural network 60. The control system 40 can then select the control signal A for transmission to the personal assistant 250 depending on the presumed desired control and/or select the control signal A for transmission to the personal assistant according to the presumed desired control 250.

This corresponding control can, for example, include the personal assistant 250 retrieving information from a database and reproducing it in a manner that is receptive to the user 249.

Instead of the personal assistant 250, a household appliance (not shown), in particular a washing machine, a stove, an oven, a microwave or a dishwasher, can also be provided in order to be controlled accordingly.

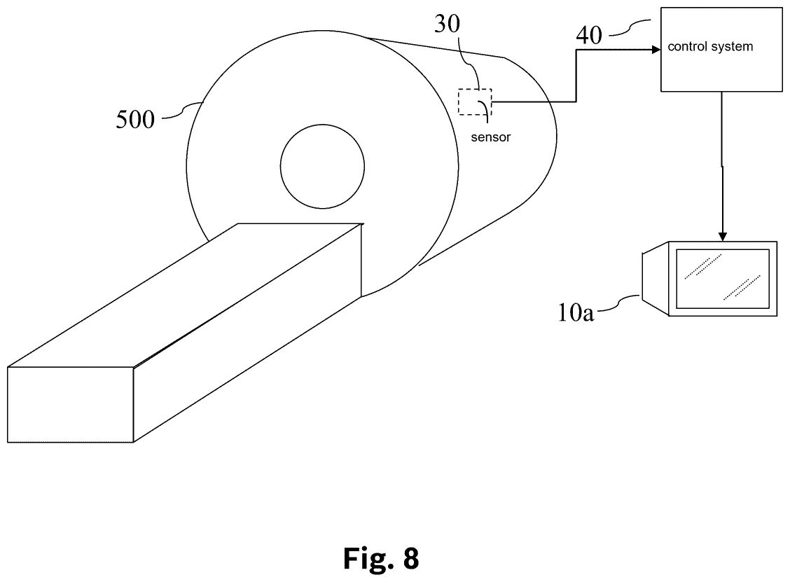

FIG. 8 shows an exemplary embodiment with which the control system 40 is used for controlling a medical imaging system 500, for example an MRI, X-ray or ultrasound device. The sensor 30 can, for example, be an imaging sensor, and the display unit 10a is controlled by the control system 40. For example, the neural network 60 can ascertain whether a region recorded by the imaging sensor is conspicuous, and the control signal A can then be selected in such a way that this region is displayed in a highlighted color by the display unit 10a.

What is claimed is:

1. A method for validating an attribution-based explainability method for a machine learning system, the method comprising the following steps:
ascertaining synthetic data points using a generator according to specified noise vectors;
ascertaining outputs of the machine learning system by propagating the synthetic data points through the machine learning system and ascertaining explanation outputs using the attribution-based explainability method for the ascertained outputs;
ascertaining scores of the explanation outputs that characterize in which section the explanation outputs lie in a distribution of explainability scores;
optimizing one of the noise vectors with regard to the score in such a way that the score moves to a rear part of the distribution of explanability scores;
ascertaining a further synthetic data point using the generator according to the optimized noise vector;
ascertaining a further output of the machine learning system by propagating the further synthetic data point through the machine learning system and ascertaining a further explanation output using the attribution-based explainability method for the further ascertained output;
ascertaining a score of the further explanation output; and
validating the attribution-based explainability method, wherein when the score lies in a rear part of a distribution of an empirically ascertained distribution of explainability scores and the further synthetic data point does not lie in a rear part of a distribution of the synthetic data points, a positive validation is given.

2. The method according to claim 1, wherein a rear part of the distribution is defined by a specified percentile.

3. The method according to claim 1, wherein the optimizing of the one of the noise vectors is carried out with a gradient-based or gradient-free optimization method.

4. The method according to claim 1, wherein the machine learning system is used for an optical inspection of produced components.

5. The method according to claim 1, wherein the synthetic data points are images and the machine learning system is an image classifier, wherein a technical system can be controlled according to classifications of the machine learning system.

6. A device configured to validating an attribution-based explainability method for a machine learning system, the system configured to:
ascertain synthetic data points using a generator according to specified noise vectors;
ascertain outputs of the machine learning system by propagating the synthetic data points through the machine learning system and ascertaining explanation outputs using the attribution-based explainability method for the ascertained outputs;
ascertain scores of the explanation outputs that characterize in which section the explanation outputs lie in a distribution of explainability scores;
optimize one of the noise vectors with regard to the score in such a way that the score moves to a rear part of the distribution of explanability scores;
ascertain a further synthetic data point using the generator according to the optimized noise vector;
ascertain a further output of the machine learning system by propagating the further synthetic data point through the machine learning system and ascertaining a further explanation output using the attribution-based explainability method for the further ascertained output;
ascertain a score of the further explanation output; and
validate the attribution-based explainability method, wherein when the score lies in a rear part of a distribution of an empirically ascertained distribution of explainability scores and the further synthetic data point does not lie in a rear part of a distribution of the synthetic data points, a positive validation is given.

7. A non-transitory machine-readable storage medium on which is stored a computer program for validating an attribution-based explainability method for a machine learning system, the computer program, when executed by a computer, causing the computer to perform the following steps:
ascertaining synthetic data points using a generator according to specified noise vectors;
ascertaining outputs of the machine learning system by propagating the synthetic data points through the machine learning system and ascertaining explanation outputs using the attribution-based explainability method for the ascertained outputs;
ascertaining scores of the explanation outputs that characterize in which section the explanation outputs lie in a distribution of explainability scores;
optimizing one of the noise vectors with regard to the score in such a way that the score moves to a rear part of the distribution of explanability scores;
ascertaining a further synthetic data point using the generator according to the optimized noise vector;
ascertaining a further output of the machine learning system by propagating the further synthetic data point through the machine learning system and ascertaining a further explanation output using the attribution-based explainability method for the further ascertained output;
ascertaining a score of the further explanation output; and
validating the attribution-based explainability method, wherein when the score lies in a rear part of a distribution of an empirically ascertained distribution of explainability scores and the further synthetic data point does not lie in a rear part of a distribution of the synthetic data points, a positive validation is given.
